(19) United States
(12) Patent Application Publication
(10) Pub. No.: US 2009/0075191 A1
(43) Pub. Date: Mar. 19, 2009

(54) ELECTROPHOTOGRAPHIC RECORDING MEDIUM

(75) Inventor: Kil KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/184,429

(22) Filed: Aug. 1, 2008

(30) Foreign Application Priority Data
Sep. 19, 2007 (KR) 2007-95449

(51) Int. Cl. G03G 15/00

(52) U.S. Cl. 430/96; 430/56

(57) ABSTRACT

An electrophotographic recording medium including a base layer and a toner receiving layer formed on one surface or both surfaces of the base layer, wherein the toner receiving layer includes a filler, a binder, a fluorescent whitening agent, and an ultraviolet absorber.

### CROSS-REFERENCE TO RELATED APPLICATIONS

This application claims priority under 35 U.S.C. §119(a) from Korean Patent Application No. 10-2007-0095449, filed on Sep. 19, 2007, in the Korean Intellectual Property Office, the disclosure of which is incorporated herein in its entirety by reference.

### BACKGROUND OF THE INVENTION

1. Field of the Invention

The present general inventive concept relates to a recording medium, and more particularly, to an electrophotographic recording medium which includes a base layer and a toner receiving layer formed on one surface or both surfaces of the base layer, wherein the toner receiving layer includes a filler, a binder, a fluorescent whitening agent, and a ultraviolet absorber.

2. Description of the Related Art

As the amount and variety of computer applications have increased, various types of documents and images are produced using computers and printed out using printers. Such printers include dot impact printers, laser printers, thermal printers, inkjet printers, and the like. Among these printers, laser printers that use a laser beam printing method (electrophotography) are widely used by general consumers in addition to inkjet printers due to high printing speeds and their ability to print high-resolution images.

Electrophotography applied to copiers or printers generally has five imaging processing steps. First, a photoconductive drum or belt is constantly charged in a dark place. Second, laser beams are irradiated to the photoconductive drum or belt to form electrostatic latent images. Third, the electrostatic latent images are exposed to charged toner to fix the toner on the electrostatic latent images by electrostatic force. Fourth, a recording medium is passed between the photoconductive drum or belt and a corona to transfer the toner to the recording medium. Herein, the recording medium must be conductive to some extent in order to transfer toner images thereto by electrostatic force. Fifth, the toner images transferred to the recording medium are fixed thereon by hot fusing in which heat and pressure are applied to the recording medium mainly using a roller.

Image supporting materials of a recording medium include common paper composed of pulp as a main component, coated paper prepared by coating a mixture of a resin, a filler, and the like on common paper, white film prepared by mixing a filler and a resin, such as polyester, and the like, etc. In the case of forming high gloss images equivalent to that of silver salt photo prints, disclosed in Japanese Patent Laid-Open Publication Nos. 2000-010329, 2000-003060 and 2002-091212, and the like, an image supporting material in which a base layer is formed of common paper, coated paper, or white film, and a layer formed of a thermoplastic resin with a predetermined thickness is formed on the base layer is preferably used.

However, conventional electrophotographic recording media become yellowed by heat, ultraviolet rays, or active oxygen, and thus whiteness and image clearness are degraded. Therefore, there is a need to develop an electrophotographic recording medium which has improved whiteness, lighffastness and discoloration resistance.

### SUMMARY OF THE INVENTION

The present general inventive concept provides an electrophotographic recording medium which includes a toner receiving layer including both a fluorescent whitening agent and an ultraviolet absorber, thus having excellent whiteness, image clearness, lighffastness, and discoloration resistance.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an electrophotographic recording medium including a base layer and a toner receiving layer formed on one surface or both surfaces of the base layer, wherein the toner receiving layer includes a filler, a binder, a fluorescent whitening agent, and an ultraviolet absorber.

The base layer may be one selected from a group consisting of synthetic paper, woodfree paper, art paper, coated paper, mixed paper, baryta paper, impregnated paper, paperboard, cellulose tissue paper, transparent or semitransparent plastic film, and foamed paper, and a laminated structure of two or more of the above materials.

The transparent or semitransparent plastic film may be selected from a group consisting of polyolefin, polyvinyl chloride, polyethylene terephthalate, polystyrene, polymethacrylate, and polycarbonate.

The thickness of the base layer may be in the range of 25 to 260 μm.

The filler may be one of an inorganic filler selected from a group consisting of kaolin clay, silica, calcium carbonate, talc, aluminum hydroxide, satin white, titanium dioxide, calcined clay, zinc oxide, and barium sulfate, and an organic filler selected from a group consisting of a styrene-based resin, an acryl-based resin, vinyl chloride, and polycarbonate.

The binder may include at least one selected from the group consisting of polyvinyl alcohol, polyvinyl pyrolidone, methyl cellulose, hydroxypropylmethyl cellulose, gelatin, polyethylene oxide, an acryl-based polymer, polyester, polyurethane, an epoxy resin, latex, and a quaternary ammonium-based copolymer.

The fluorescent whitening agent may include at least one selected from a group consisting of a stilbene-based compound, a benzimidazole-based compound, a benzoxazole-based compound, a naphthalimide-based compound, a rhodamine-based compound, a cumarine-based compound, an oxazine-based compound, a pyrazoline-based compound, a bisstilbiphenyl-based compound, and a triazole-based compound.

The ultraviolet absorber may be at least one selected from a group consisting of a benzophenone-based ultraviolet absorber, a benzotriazole-based ultraviolet absorber, a salicylic acid-based ultraviolet absorber, a cyano acrylate-based ultraviolet absorber, a benzoxazine-based ultraviolet absorber, and a hydroxyphenyltriazine-based ultraviolet absorber.

The toner receiving layer may further include an additive.

An amount of the additive may be about 1 to 15 parts by weight based on 100 parts by weight of total solids of the toner receiving layer.

The additive may be at least one of an antistatic agent, a cross-linking agent, a dye, a light diffusing agent, a pH adjuster, an antioxidant, an antifoaming agent, a defoamer, a leveler, a lubricant, an anticurling agent, a surface conditioner, a thickener, a degradation inhibitor, an ozone degradation inhibitor, and an antiseptic.

The thickness of the toner receiving layer may be in the range of 1 to 20 μm.

The electrophotographic recording medium may further include an outermost layer formed on the toner receiving layer.

The outermost layer may include a binder and a filler.

The thickness of the outermost layer may be in the range of 5 to 15 μm.

An amount of the filler in the outermost layer may be about 5 to 60 parts by weight based on 100 parts by weight of total solids of the outermost layer 22.

An amount of the binder in the outermost layer may be about 40 to 95 parts by weight based on 100 parts by weight of total solids of the outermost layer 22.

The outermost layer further may further include an additive.

The foregoing and/or other aspects and utilities of the present general inventive concept may also be achieved by providing a printing medium, usable in electrophotographic apparatuses, the printing medium including a base layer, and a toner receiving layer formed on the base layer, the toner receiving layer comprising a filler, a binder, and at least one of a fluorescent whitening agent and an ultraviolet absorber.

The toner receiving layer may include both the fluorescent whitening agent and the ultraviolet absorber.

The toner receiving layer may be formed on one surface of the base layer.

The toner receiving layer may be formed on at least two surfaces of the base layer.

A ratio of the filler to the binder in the toner receiving layer may be in the range of about 95:5 to 10:90.

An amount of the filler and binder may be about 60 to 99 parts by weight based on 100 parts by weights of total solids in the toner receiving layer.

An amount of the fluorescent whitening agent may be about 0.01 to 20 parts by weight based on 100 parts by weights of total solids in the toner receiving layer.

An amount of the ultraviolet absorber may be about 0.01 to 20 parts by weight based on 100 parts by weights of total solids in the toner receiving layer.

The foregoing and/or other aspects and utilities of the present general inventive concept may also be achieved by providing a method of preparing a printing medium usable in electrophotographic apparatuses, the method including preparing a toner receiving composition having a binder, a filler, and at least one of a fluorescent whitening agent and an ultraviolet absorber, disposing the toner receiving composition on at least one surface of a base layer, and drying the toner receiving composition to form a toner receiving layer on the base layer.

The drying of the toner receiving composition may be performed at about 50° C. to 130° C.

The toner receiving composition may further include a cross-linking agent.

The method may further include forming an outermost layer on the toner receiving layer.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view of an electrophotographic recording medium according to an embodiment of the present general inventive concept; and

FIG. 2 is a cross-sectional view of an electrophotographic recording medium according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general inventive concept provides an electrophotographic recording medium which includes a base layer and a toner receiving layer formed on one surface or both surfaces of the base layer, wherein the toner receiving layer includes a filler, a binder, a fluorescent whitening agent, and a ultraviolet absorber.

That is, according to the purpose of the use, the toner receiving layer may be formed on one surface of the base layer, or may be formed on both surfaces of the base layer.

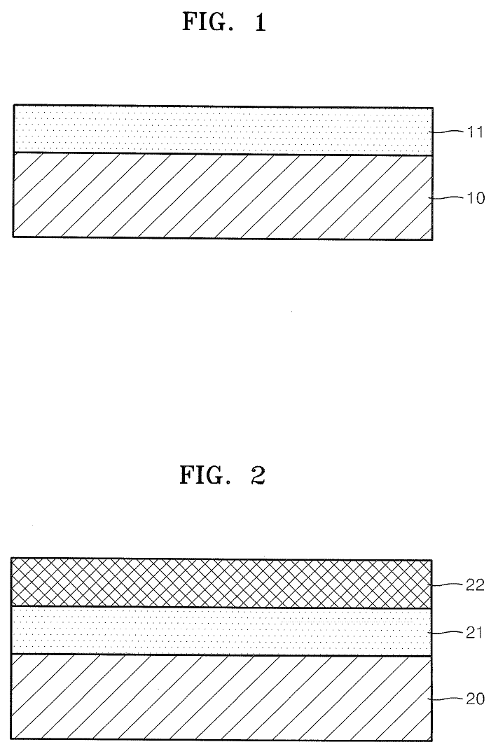

FIG. 1 is a cross-sectional view of an electrophotographic recording medium according to an embodiment of the present general inventive concept. Referring to FIG. 1, the electrophotographic recording medium according to the current embodiment of the present general inventive concept includes a base layer 10 and a toner receiving layer 11 formed on the base layer 10.

The base layer 10 may be formed of a material which can be used in a base layer of a conventional electrophotographic recording medium, and is not particularly limited. That is, the material used to form the base layer 10 can be a material which can endure a fixing temperature and satisfy requirements, such as smoothness, whiteness, friction, antistatic property, fixability, and the like, and may be appropriately selected according to the purpose of the use. In particular, the material may be synthetic paper (for example, polyolefins, polystyrenes, and the like), woodfree paper, art paper, coated paper, mixed paper prepared from a natural pulp and a synthetic resin pulp, such as polyethylene, and the like, baryta paper, a synthetic resin, or a paper support, such as emulsion impregnated paper, synthetic rubber latex impregnated paper, paperboard, cellulose tissue paper, and the like. In addition, the material may be a plastic film support, such as polyolefin, polyvinyl chloride, polyethylene terephthalate, polystyrene, polymethacrylate, polycarbonate, or the like. In addition, the material may be a white opaque film prepared by adding a pigment or a filler to the synthetic resin, a foamed sheet prepared by foaming the synthetic resin, or the like. The base layer 10 may include a single-layered structure or may include a combination of two or more layers, that is, in the form of a laminated structure. For example, a laminated structure of cellulose tissue paper and synthetic paper or a laminated structure of cellulose tissue paper and a plastic film.

The base layer 10 may have a high surface smoothness. In particular, a surface roughness (smoothness) of the base layer 10, which is measured using a Bekk method (KSM7028) may be 210 seconds or more, or may be 250 seconds or more. When the surface roughness of the base layer is less than 210 seconds, image quality may be degraded when images are formed. A thickness of the base layer 10 can be set according to the purpose of the use of the electrophotographic recording medium, and the like, and may be in the range of 25 to 260 μm, or may be 75 to 220 μm. If an adhesion between the base layer 10 and the toner receiving layer 11 formed on a surface of the base layer 10, which is to be later described, is not sufficient, the surface of the base layer 10 may be treated with primer, treated with corona discharge, or the like.

The toner receiving layer 11 may be formed of known components used in a conventional recording medium. The main components of the toner receiving layer 11 may be a filler and a binder. The filler may be an inorganic filler or an organic filler.

An average particle diameter of particles of the inorganic filler may be 2.5 microns or less, or may be in the range of 2.0 to 0.1 microns. The inorganic filler may be kaolin clay, silica, calcium carbonate, talc, aluminum hydroxide, satin white, titanium dioxide, calcined clay, zinc oxide, barium sulfate, or the like. The organic filler may be a styrene-based resin, such as polystyrene, polymethylstyrene, and the like; an acryl-based resin, such as polymethacrylic acid methyl, polyacrylonitrile, and the like; vinyl chloride, polycarbonate, or the like, or may be mixtures thereof mixed in a certain ratio.

A mixed ratio of the filler to the binder may be in the range of 95:5 to 10:90, in the range of 95:5 to 40:60, or may be in the range of 95:5 to 60:40. When the mixed ratio of the filler to the binder is greater than 95:5, the adhesion between the base layer 10 and the toner receiving layer 11 including the filler and the binder is degraded. On the other hand, when the mixed ratio of the filler to the binder is less than 10:90, most of the filler is buried in the binder so that the filler can not carry out its function.

The binder may be at least one of polyvinyl alcohol, polyvinyl pyrolidone, methyl cellulose, hydroxypropylmethyl cellulose, gelatin, polyethylene oxide, an acryl-based polymer, polyester, polyurethane, an epoxy resin, latex, and a quaternary ammonium-based copolymer.

Here, the latex may be a styrene-butadiene latex, a styrene-butadiene-acrylonitrile latex, an acryl-based latex, or the like.

An amount of the filler and binder may be in the range of 60 to 99 parts, or may be in the range of 70 to 95 parts by weight based on 100 parts by weight of total solids of the toner receiving layer 11. When the amount of the filler and binder is less than 60 parts by weight based on 100 parts by weight of total solids of the toner receiving layer 11, toner is not sufficiently fixed on the toner receiving layer, and the adhesion between the base layer 10 and the toner receiving layer 11 is degraded. On the other hand, when the amount of the filler and binder is greater than 99 parts by weight based on 100 parts by weight of total solids of the toner receiving layer 11, coating surface properties are degraded to the point where cracks occur in the toner receiving layer 11.

The toner receiving layer 11 includes a fluorescent whitening agent used to improve whiteness of a recording medium. The fluorescent whitening agent may be a stilbene-based compound, a benzimidazole-based compound, a benzoxazole-based compound, a naphthalimide-based compound, a rhodamine-based compound, a cumarine-based compound, an oxazine-based compound, a pyrazoline-based compound, a bisstilbiphenyl-based compound, a triazole-based compound, or the like. The fluorescent whitening agent may be used alone or in combination of two or more.

The above fluorescent whitening agents may be available on the market under the product names of the Uvitex series and the Tinopal series from Ciba Specialty Chemicals, the Kayacoll series from Nippon Soda Co., Ltd. (for example, Kaycol BBL, bistriazinylaminostilbene disulfonic acid salt derivatives), the Whitex series from Sumitomo Chemical Co., Ltd., the Kayaphor series from Nippon Kayaku Co., Ltd., the Blankophor series from Bayer AG, and the like.

An amount of the fluorescent whitening agent may be in the range of 0.01 to 20 parts by weight, or may be in the range of 0.1 to 10 parts by weight based on 100 parts by weight of total solids of the toner receiving layer 11. When the amount of the fluorescent whitening agent is less than 0.01 parts by weight based on 100 parts by weight of total solids of the toner receiving layer 11, the whiteness of the electrophotographic recording medium can not be sufficiently obtained. On the other hand, when the amount of the fluorescent whitening agent is greater than 20 parts by weight based on 100 parts by weight of total solids of the toner receiving layer 11, a compatibility with the filler and binder may be degraded to the point where significant effect is not obtained, and thus it is not economical.

In addition, the toner receiving layer 11 may include an ultraviolet absorber. The ultraviolet absorber may be a benzophenone-based ultraviolet absorber, a benzotriazole-based ultraviolet absorber, a salicylic acid-based ultraviolet absorber, a cyano acrylate-based ultraviolet absorber, a benzoxazine-based ultraviolet absorber, a hydroxyphenyltriazine-based ultraviolet absorber, or the like. These ultraviolet absorbers may be used alone or in combination of two or more.

In particular, the benzophenone-based ultraviolet absorber may be 2,4-dihydroxybenzophenone, 2-hydroxy-4-methoxybenzophenone, 2-hydroxy-4-dodecyloxybenzophenone, 2-hydroxy-4-oxybenzophenone, 2-hydroxy-4-octoxybenzophenone, 2-hydroxy-4-benzyloxybenzophenone, 2-hydroxy-4-methoxy-5-sulfobenzophenone, 2-hydroxy-4-methoxy-5-sulfoxytrihydratebenzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxybenzophenone, bis(5-benzoyl-4-hydroxy-2-methoxyphenyl)methane, 2-hydroxy-4-n-dodecyloxybenzophenone, 2-hydroxy-4-methoxy-2′-carboxybenzophenone, or the like.

The benzotriazole-based ultraviolet absorber may be 2-(2′-hydroxy-3′-methyl-5′-methylphenyl)benzotriazole, 2-(2′-hydroxy-5′-methylphenyl)benzotriazole, 2-(2′-hydroxy-5′-tert-octylphenyl)benzotriazole, 2-(2′-hydroxy-3′,5′-dicumylphenyl)phenylbenzotriazole, 2-(2′-hydroxy-3′-tert-butyl-5′-methylphenyl)-5-chlorobenzotriazole, 2,2′-methylenebis[4-(1,1,3,3-tetramethylbutyl)-6-(2H-benzotriazole-2-yl)phenol], 2-(2′-hydroxy-3′,5′-di-tert-butylphenyl)benzotriazole, 2-(2′-hydroxy-3′,5′-di-tert-butylphenyl)-5-chlorobenzotriazole, 2-(2′-hydroxy-3′,5′-di-tert-amylphenyl)benzotriazole, 2-(2′-hydroxy-5′-tert-octylphenyl)benzotriazole, 2-(2′-hydroxy-5′-tert-butylphenyl)benzotriazole, 2-(2′-hydroxy-4′-octoxyphenyl)benzotriazole, 2,2′-methylenebis(4-cumyl-6-benzotriazolephenyl), 2,2′-p-phenylenebis(1,3-benzoxazine-4-one), 2-[2-hydroxy-3-(3,4,5,6-tetrahydroimidemethyl)-5-methylphenyl]benzotriazole, or the like.

The salicylic acid-based ultraviolet absorber may be phenylsalicylate, p-t-butylphenylsalicylate, p-oxyphenylsalicylate, or the like.

The cyano acrylate-based ultraviolet absorber may be 2-ethylhexyl-2-cyano-3,3-diphenylacrylate, ethyl-2-cyano-3,3-diphenylacrylate, or the like.

The benzoxazine-based ultraviolet absorber may be 2,2′-p-phenylenebis(3,1-benzoxazine-4-one), 2,2′-p,p′-diphenylenebis(3,1-benzoxazine-4-one), or the like.

In addition, the hydroxyphenyltriazine-based ultraviolet absorber may be 2-(4,6-diphenyl-1,3,5-triazine-2-yl)-5-hexyloxyphenol, 2-(4,6-diphenyl-1,3,5-triazine-2-yl)-5-methyloxyphenol, 2-(4,6-diphenyl-1,3,5- triazine -2-yl)-5-ethyloxyphenol, 2-(4,6-diphenyl-1,3,5-triazine-2-yl)-5-propyloxyphenol, 2-(4,6-diphenyl-1,3,5-triazine-2-yl)-5-butyloxyphenol, or the like. In addition, the hydroxyphenyltriazine-based ultraviolet absorber may be compounds in which phenyl groups of the compounds described above are substituted with 2,4-dimethylphenyl groups, such as 2-(4,6-bis(2,4-dimethylphenyl)-1,3,5-triazine-2-yl)-5-hexyloxyphenol, and the like.

These ultraviolet absorbers can be used alone or in combination of two or more.

An amount of the ultraviolet absorber may be in the range of 0.01 to 20 parts by weight, or may be in the range of 0.1 to 10 parts by weight based on 100 parts by weight of total solids of the toner receiving layer 11. When the amount of the ultraviolet absorber is less than 0.01 parts by weight based on 100 parts by weight of total solids of the toner receiving layer 11, an effect of blocking ultraviolet rays can not be obtained. On the other hand, when the amount of the ultraviolet absorber is greater than 20 parts by weight based on 100 parts by weight of total solids of the toner receiving layer 11, the compatibility with filler and binder is degraded such that a smoothness and transparency of the toner receiving layer are reduced and a strength thereof is reduced.

The toner receiving layer 11 may further include any additives which improve the stability of printed images or the toner receiving layer 11 itself, improve processability of the electrophotographic recording medium, and the like, and thus can complement the physical properties of the toner receiving layer 11. Such additives may include an antistatic agent, a cross-linking agent, a dye, a light diffusing agent, a pH adjuster, an antioxidant, an antifoaming agent and defoamer, a leveler, a lubricant, an anticurling agent, a surface conditioner, a thickener, a degradation inhibitor, an ozone degradation inhibitor, an antiseptic, and the like, which are known in the art.

In an electrophotographic printing method, such as a laser beam printing method, toner is charged and attached to printing paper using the charge, and thus the electroconductivity of the paper highly affects an accurate image formation (electroconductivity may represent surface resistance of a coated layer. Generally, surface resistance is used instead of electroconductivity, and thus the term “surface resistance” is used herein together with the term “electroconductivity”). Therefore, as components constituting the base layer 10 and toner receiving layer 11, an electroconductive polymer or additives, for example, an antistatic agent, and the like can be added in order to provide electrical conductivity. The antistatic agent, which is an additive used to provide conductivity may be an inorganic dye, such as sodium chloride, potassium chloride, or the like, a polyhydric alcohol, such as glycerine, propyleneglycol, ethyleneglycol, polyethyleneglycol, trimethyleneglycol, sorbitol, or the like, a quaternary ammonium salt, or the like. These antistatic agents provide conductivity, thereby having an antistatic function, and solve problems caused by continuous paper feeding due to static electricity generation. Thus, the term “antistatic agent” is used instead of a conducting agent.

When an electroconductive polymer or an antistatic agent is used to form the base layer 10 or toner receiving layer 11, it is preferable that the surface resistance of the toner receiving layer 11 may be maintained in the range of 10⁹ to 10¹⁴Ω (measured at 20° C. and a relative humidity of 20%). This surface resistance is suitable to fix toner and to prevent toner scatter. In a conventional recoding medium, surface resistance is adjusted according to the anti-static agent used, such as an inorganic dye, for example, sodium chloride, potassium chloride, or the like, a quaternary ammonium salt, or the like. However, it is difficult to control the surface resistance in a certain range using these components under varying temperature and humidity conditions. For example, the surface resistance at a high temperature and a high humidity, for example, at 32° C. and a relative humidity of 90%, may be reduced, thus causing poor transferring of toner.

A total amount of the additives contained in the toner receiving layer 11 may be in the range of about 1 to about 15 parts by weight based on 100 parts by weight of total solids of the toner receiving layer 11. When the total amount of the additives is less than 1 part by weight based on 100 parts by weight of total solids of the toner receiving layer 11, the effect of adding the additives may be insignificant. On the other hand, when the total amount of the additives is greater than 15 parts by weight based on 100 parts by weight of total solids of the toner receiving layer 11, the smoothness, intensity, and the like of the toner receiving layer 11 are degraded.

A thickness of the toner receiving layer 11 may be in the range of about 1 to 20 μm, or may be in the range of 5 to 10 μm. When the thickness of the toner receiving layer 11 is less than 1 μm, the toner receiving layer cannot perform its function. When the thickness of the toner receiving layer 11 is greater than 20 μm, costs increase and the toner receiving layer 11 cannot be easily dried when the composition used to form a toner receiving layer is coated.

The electrophotographic recording medium according to the present general inventive concept may further include an outermost layer formed on a toner receiving layer.

FIG. 2 is a cross-sectional view of an electrophotographic recording medium according to another embodiment of the present general inventive concept. Referring to FIG. 2, the electrophotographic recording medium according to the current embodiment of the present general inventive concept includes a base layer 20, a toner receiving layer 21 formed on the base layer 20, and an outermost layer 22 formed on the toner receiving layer 21.

These electrophotographic recording mediums include the outermost layer in order to have gloss properties, and the outermost layer includes a binder and a filler as in the toner receiving layer described above.

Herein, the outermost layer 22 includes a smaller amount of the filler than that of the filler included in the toner receiving layer 21, or includes an organic filler as the filler, and thereby the effect of adding the filler can be obtained. In addition, the outermost layer 22 can be formed as a resin layer formed primarily of the binder.

The binder may be, as described above, at least one of polyvinyl alcohol, polyvinyl pyrolidone, methyl cellulose, hydroxypropylmethyl cellulose, gelatin, polyethylene oxide, an acryl-based polymer, polyester, polyurethane, an epoxy resin, latex, and a quaternary ammonium-based copolymer.

Here, the latex may be a styrene-butadiene latex, a styrene-butadiene-acrylonitrile latex, an acryl-based latex, or the like.

The amount of the binder included in the outermost layer 22 may be in the range of 40 to 95 parts by weight, or may be in the range of 60 to 90 parts by weight based on 100 parts by weight of total solids of the outermost layer 22. When the amount of the binder is less than 40 parts by weight based on 100 parts by weight of total solids of the outermost layer 22, gloss properties are degraded such that the effect of absorption of ultraviolet rays can not be expected. On the other hand, when the amount of the binder is greater than 95 parts by weight based on 100 parts by weight of total solids of the outermost layer 22, the viscosity of a solution used to form the outermost layer 22 is increased.

The filler included in the outermost layer 22 may be, as described above, an inorganic filler or an organic filler.

An average particle diameter of particles of the inorganic filler may be 2.5 microns or less, or may be in the range of 2.0 to 0.1 microns. The inorganic filler may be kaolin clay, silica, calcium carbonate, talc, aluminum hydroxide, satin white, titanium dioxide, calcined clay, zinc oxide, barium sulfate, or the like. The organic filler may be a styrene-based resin, such as polystyrene, polymethylstyrene, or the like; an acryl-based resin, such as polymethacrylic acid methyl, polyacrylonitrile, or the like; vinyl chloride, polycarbonate, or the like, or may be mixtures thereof mixed in a certain ratio.

The amount of the filler may be in the range of 5 to 60 parts by weight, or may be in the range of 10 to 40 parts by weight based on 100 parts by weight of total solids of the outermost layer 22. When the amount of the filler is less than 5 parts by weight based on 100 parts by weight of total solids of the outermost layer 22, most of the filler is buried in the binder so that the filler can not perform its function. On the other hand, when the amount of the filler is greater than 60 parts by weight based on 100 parts by weight of total solids of the outermost layer 22, gloss properties are degraded such that the effect of the outermost layer 22 can not be expected.

The outermost layer 22 may further include any additives which improve the stability of printed images or the outermost layer 22 itself, improve processability of the electrophotographic recording medium, and the like, and thus can complement the physical properties of the outermost layer 22. Such additives may include an antistatic agent, a cross-linking agent, a dye, a fluorescent whitening agent, a light diffusing agent, a pH adjuster, an antioxidant, an antifoaming agent and defoamer, a leveler, a lubricant, an anticurling agent, a surface conditioner, a thickener, an ultraviolet absorber, a degradation inhibitor, an ozone degradation inhibitor, an antiseptic, and the like, which are known in the art.

A total amount of the additives contained in the outermost layer 22 may be in the range of about 1 to about 15 parts by weight, or may be in the range of 2 to 10 parts by weight based on 100 parts by weight of total solids of the outermost layer 22. When the total amount of the additives is less than 1 part by weight based on 100 parts by weight of total solids of the outermost layer 22, an effect of adding the additives may be insignificant. On the other hand, when the total amount of the additives is greater than 15 parts by weight based on 100 parts by weight of total solids of the outermost layer 22, the smoothness, transparency and strength of the outermost layer 22 are degraded.

The thickness of the outermost layer 22 may be in the range of about 5 to about 15 μm, or may be in the range of about 5 to about 10 μm. When the thickness of the outermost layer 22 is less than 5 μm, the effect of the outermost layer can not be obtained. Moreover, it is difficult to prepare the outermost layer 22 to have a thickness greater than 15 μm, and thus costs increase.

The toner receiving layer 21 is formed by coating a composition used to form a toner receiving layer on a base layer and drying the composition, and the outermost layer 22 is formed by coating a composition used to form an outermost layer on a base layer and drying the composition.

The compositions used to form the toner receiving layer 21 and the outermost layer 22 may further include a solvent in addition to the solids included in the toner receiving layer 21 and outermost layer 22 described above.

The solvent is not particularly limited, but may be water, taking into consideration environmental problems, work efficiencies, and the like.

The solvent may be, in addition to water, selected from ketones, glycol ethers, alcohols, methylcellosolve, ethylcellosolve, dimethyl formamide, and dimethyl sulfoxide. In particular, the ketones may be acetone and methyl ethyl ketone, the glycol ethers may be diethylene glycol and diethylene glycol monobutyl ether, and the alcohols may be methanol, ethanol, butanol, isopropanol, and the like.

An amount of the solids of the compositions used to form the toner receiving layer 21 and outermost layer 22 may be 5 to 60 wt % based on 100 wt % of the solvent. When the amount of the solids is less than 5 wt % based on 100 wt % of the solvent, the compositions used to form the toner receiving layer 21 and outermost layer 22 can not be dried when being coated. On the other hand, when the amount of the solids is greater than 60 wt % based on 100 wt % of the solvent, the viscosity of the compositions is too high and thus cracks may occur or unwanted defects may be generated in one or both of the toner receiving layer 21 and outermost layer 22, resulting in poor coated surface properties. The electrophotographic recording medium according to the current embodiment of the present general inventive concept is prepared by sequentially coating the composition used to form the toner receiving layer 21 and the composition used to form the outermost layer 22 on one or both surfaces of the base layer 20 and drying the compositions to form the toner receiving layer 21 and the outermost layer 22.

The drying process may be performed at a temperature in a range of about 50 to 130° C. In this process, when a cross-linking agent is included in the compositions used to form the toner receiving layer 21 and the outermost layer 22, thermal cross-linking reaction occurs due to the cross-linking agent. Therefore, when the drying temperature is less than 50° C., cross-linking reactivity is deteriorated. On the other hand, when the drying temperature is greater than 130° C., yellowing may occur.

After the coating and drying of the composition used to form the toner receiving layer 21, calendar devices, such as machine calendars, TG calendars, soft calendars, super calendars, and the like may, be used as an on-machine (a coating method during papermaking in a drying unit of a paper machine) or an off-machine (a method of coating paper made by a paper machine using a separate coater) in order to improve smoothness and gloss properties.

Hereinafter, the present general inventive concept will be described more specifically with reference to the following examples. The following examples are for illustrative purposes only and are not intended to limit the scope of the general inventive concept.

### EXAMPLE 1

A composition used for forming a toner receiving layer was as follows.

[Composition used for Forming a Toner Receiving Layer]

| | | |
|---|---|---|
| Calcium carbonate (OMAYA Company, | 80 | parts by weight |
| Hydrocarb 60 ME) | | |
| Polyvinyl alcohol (KURARAY Company | 1 | part by weight |
| Ltd., PVA 105) | | |
| Acryl-based latex (Hansol Chemical | 6 | parts by weight |
| Company Ltd., SAV 4720) | | |
| Fluorescent whitening agent | 2 | parts by weight |
| (bistriazinylaminostylbene | | |
| disulfonic acid salt derivative KaycollBBL, | | |
| Nippon Soda Company Ltd.) | | |
| Ultraviolet absorber | 3 | parts by weight |
| (2-[2′-hydroxy-3′-methyl-5′- | | |
| methylphenyl]benzotriazole from Evergreen) | | |
| Sodium chloride (Junsei Company) | 3 | parts by weight |
| Polyethylene glycol (Junsei Company) | 5 | parts by weight |
| Water | 400 | parts by weight |

The above composition used to form a toner receiving layer was coated on base paper having a basis weight of 115 g/m² using a bar coater, and then the composition was dried at 110° C. for 3 minutes to form a toner receiving layer with a thickness of about 15 μm. As a result, preparation of an electrophotographic recording medium was completed.

### EXAMPLE 2

Compositions used to form a toner receiving layer and an outermost layer were as follows.

[Composition used for Forming a Toner Receiving Layer]

| | | |
|---|---|---|
| Calcium carbonate (OMAYA Company, | 83 | parts by weight |
| Hydrocarb 60 ME) | | |
| Polyvinyl alcohol (KURARAY | 1 | part by weight |
| Company Ltd., PVA 105) | | |
| Acryl-based latex (Hansol Chemical | 6 | parts by weight |
| Company Ltd., SAV 4720) | | |
| Fluorescent whitening agent | 2 | parts by weight |
| (bistriazinylaminostylbene disulfonic acid | | |
| salt derivative KaycollBBL, Nippon | | |
| Soda Company Ltd.) | | |
| Ultraviolet absorber (2-[2′-hydroxy-3′- | 2 | parts by weight |
| methyl-5′- | | |
| methylphenyl]benzotriazole | | |
| from Evergreen) | | |
| Sodium Chloride (Junsei Company) | 2 | parts by weight |
| Polyethylene glycol (Junsei Company) | 4 | parts by weight |
| Water | 400 | parts by weight |

[Composition used for Forming an Outermost Layer]

| | |
|---|---|
| Calcium carbonate (SMI Company, Opacarb A40) | 83 parts by weight |
| Organic filler (Dow Company, DPP 3720) | 3 parts by weight |
| Polyvinyl alcohol (KURARAY Company Ltd., | 1 part by weight |
| PVA 105) | |
| Acryl-based latex (Hansol Chemical Company | 6 parts by weight |
| Ltd., SAV 4720) | |
| Zirconium oxy chloride (Junsei Company) | 3 parts by weight |
| Sodium Chloride (Junsei Company) | 3 parts by weight |
| Polyethylene glycol (Junsei Company) | 4 parts by weight |
| Water | 400 parts by weight |

The above compositions used to form a toner receiving layer and an outermost layer were sequentially coated on base paper having a base weight of 110 g/m² using a bar coater, and then the compositions were dried at 110° C. for 3 minutes to form a toner receiving layer with a thickness of about 10 μm and an outermost layer with a thickness of about 11 μm. As a result, preparation of an electrophotographic recording medium was completed.

### COMPARATIVE EXAMPLE 1

An electrophotographic recording medium was prepared in the same manner as in Example 1, except that the composition of a toner receiving layer was as follows.

| | | |
|---|---|---|
| Calcium carbonate (OMIYA Company, | 85 | parts by weight |
| Hydrocarb 60 ME) | | |
| Polyvinyl alcohol (KURARAY | 1 | part by weight |
| Company Ltd., PVA 105) | | |
| Latex (Hansol Chemical Company Ltd., | 7 | parts by weight |
| SAV 4720) | | |
| Sodium Chloride (Junsei Company) | 3 | parts by weight |
| Polyethylene glycol (Junsei Company) | 4 | parts by weight |
| Water | 400 | parts by weight |

### COMPARATIVE EXAMPLE 2

An electrophotographic recording medium was prepared in the same manner as in Example 1, except that the composition of a toner receiving layer was as follows.

| | | |
|---|---|---|
| Calcium carbonate (OMIYA Company, | 82 | parts by weight |
| Hydrocarb 60 ME) | | |
| Polyvinyl alcohol (KURARAY Company Ltd., | 1 | part by weight |
| PVA 105) | | |
| Latex (Hansol Chemical Company Ltd., | 7 | parts by weight |
| SAV 4720) | | |
| Fluorescent whitening agent | 3 | parts by weight |
| (bistriazinylaminostylbene disulfonic acid | | |
| salt derivative KaycollBBL, Nippon Soda | | |
| Company Ltd.) | | |
| Sodium Chloride (Junsei Company) | 3 | parts by weight |
| Polyethylene glycol (Junsei Company) | 4 | parts by weight |
| Water | 400 | parts by weight |

### COMPARATIVE EXAMPLE 3

An electrophotographic recording medium was prepared in the same manner as in Example 1, except that the composition of a toner receiving layer was as follows.

| | | |
|---|---|---|
| Calcium carbonate (OMIYA Company, | 82 | parts by weight |
| Hydrocarb 60 ME) | | |
| Polyvinyl alcohol (KURARAY Company Ltd., | 1 | part by weight |
| PVA 105) | | |
| Latex (Hansol Chemical Company Ltd., | 7 | parts by weight |
| SAV 4720) | | |
| Ultraviolet absorber | 3 | parts by weight |
| (2-hydroxy-4-methoxybenzophenone from | | |
| Evergreen) | | |
| Sodium chloride (Junsei Company) | 3 | parts by weight |
| Polyethylene glycol (Junsei Company) | 4 | parts by weight |
| Water | 400 | parts by weight |

Image printing was performed on the electrophotographic recording media according to Examples 1 and 2 and Comparative Examples 1 through 3 using a color laser beam printer (CLP-300) from Samsung Electronics.

Lighffastness and fading resistance of the electrophotographic recording media according to Examples 1 and 2 and Comparative Examples 1 through 3 on which images were printed were evaluated. Each of the properties was evaluated as follows.

### [Evaluation Method]

### (1). Lightfastness Test

Irradiation was performed using a lighffastness tester (Q-SUN 3000; Xenon lamp) at an irradiation energy of 1.1W/M² at 420 nm and a black panel temperature of 63° C. for 10 hours. Using the same printer as described above, β images of yellow, magenta, cyan, and black were printed on the electrophotographic recording media according to Examples 1 and 2 and Comparative Examples 1 through 3, and then L*, a*, and b* were measured using Spectrophotometer (Spectroeye, Gretag Macbeth), wherein L* refers to luminosity, a* refers to position of axis of complementary colors of red and green, and b* refers to position of axis of complementary colors of yellow and blue. ΔE of each of the electrophotographic recording media was obtained from values measured before test and after test, and was evaluated using the following evaluation standard: ⊚:ΔE is less than 3, ∘: ΔE is from 3 to less than 7, Δ:ΔE is from 7 to less than 10, and x:ΔE is 10 or more.

### (2) Fading Resistance Test

Using a gas corrosion tester (TG100-ISO, SUGA), the electrophotographic recording media according to Examples 1 and 2 and Comparative Examples 1 through 3 were subjected to a mixed gas (O₃, SQ₂, NO₂) for 2 hours. Using the same printer as described above, β images of yellow, magenta, cyan, and black were printed on the electrophotographic recording media, and then L*, a*, and b* were measured using Spectrophotometer (Spectroeye, Gretag Macbeth). ΔE of each of the electrophotographic recording media was obtained from the values measured before test and after test, and was evaluated using the following evaluation standard: ⊚:ΔE is less than 3, ∘:ΔE is from 3 to less than 7, Δ:ΔE is from 7 to less than 10, and ×:ΔE is 10 or more.

TABLE 1

| | | | Compar- | Compar- | Compar- |
|---|---|---|---|---|---|
| | | | ative | ative | ative |
| | Example 1 | Example 2 | Example 1 | Example 2 | Example 3 |
| Lightfastness | ⊚ | ⊚ | x | x | ∘ |
| Fading | ∘ | ∘ | x | ∘ | Δ |
| resistance | | | | | |

⊚: excellent,
∘: good,
Δ: poor,
x: very poor

As illustrated in Table. 1, the electrophotographic recording media prepared in Examples 1 and 2 have excellent lighffastness and fading resistance by including a fluorescent whitening agent and ultraviolet absorber in the toner receiving layer.

The electrophotographic recording medium of Comparative Example 1 does not include both a fluorescent whitening agent and an ultraviolet absorber, thereby having poor lighffastness and fading resistance. In the case of the electrophotographic recording medium of Comparative Example 2 that includes only the fluorescent whitening agent, discoloration resistance is good due to the effect of the fluorescent whitening agent, while lighffastness is significantly degraded. In the case of the electrophotographic recording medium of Comparative Example 3 that includes only the ultraviolet absorber, the ultraviolet absorber enhances lighffastness and also improves somewhat discoloration resistance; however, the improvements are less than those shown in Examples 1 and 2.

According to the present general inventive concept, an electrophotographic recording medium includes a toner receiving layer including a fluorescent whitening agent and an ultraviolet absorber, thereby having excellent whiteness, image clearness, lighffastness, and fading resistance.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electrophotographic recording medium comprising a base layer and a toner receiving layer formed on one surface or both surfaces of the base layer, wherein the toner receiving layer comprises a filler, a binder, a fluorescent whitening agent, and an ultraviolet absorber.

2. The electrophotographic recording medium of claim 1, wherein the base layer is one selected from a group consisting of synthetic paper, woodfree paper, art paper, coated paper, mixed paper, baryta paper, impregnated paper, paperboard, cellulose tissue paper, transparent or semitransparent plastic film, and foamed paper, and a laminated structure of two or more of the above materials.

3. The electrophotographic recording medium of claim 2, wherein the transparent or semitransparent plastic film is selected from a group consisting of polyolefin, polyvinyl chloride, polyethylene terephthalate, polystyrene, polymethacrylate, and polycarbonate.

4. The electrophotographic recording medium of claim 1, wherein the thickness of the base layer is in the range of 25 to 260 μm.

5. The electrophotographic recording medium of claim 1, wherein the filler is one of an inorganic filler selected from a group consisting of kaolin clay, silica, calcium carbonate, talc, aluminum hydroxide, satin white, titanium dioxide, calcined clay, zinc oxide, and barium sulfate, and an organic filler selected from a group consisting of a styrene-based resin, an acryl-based resin, vinyl chloride, and polycarbonate.

6. The electrophotographic recording medium of claim 1, wherein the binder comprises at least one selected from the group consisting of polyvinyl alcohol, polyvinyl pyrolidone, methyl cellulose, hydroxypropylmethyl cellulose, gelatin, polyethylene oxide, an acryl-based polymer, polyester, polyurethane, an epoxy resin, latex, and a quaternary ammonium-based copolymer.

7. The electrophotographic recording medium of claim 1, wherein the fluorescent whitening agent comprises at least one selected from a group consisting of a stilbene-based compound, a benzimidazole-based compound, a benzoxazole-based compound, a naphthalimide-based compound, a rhodamine-based compound, a cumarine-based compound, an oxazine-based compound, a pyrazoline-based compound, a bisstilbiphenyl-based compound, and a triazole-based compound.

8. The electrophotographic recording medium of claim 1, wherein the ultraviolet absorber is at least one selected from a group consisting of a benzophenone-based ultraviolet absorber, a benzotriazole-based ultraviolet absorber, a salicylic acid-based ultraviolet absorber, a cyano acrylate-based ultraviolet absorber, a benzoxazine-based ultraviolet absorber, and a hyd roxyphenyltriazine-based ultraviolet absorber.

9. The electrophotographic recording medium of claim 1, wherein the toner receiving layer further comprises an additive.

10. The electrophotographic recording medium of claim 9, wherein an amount of the additive is about 1 to 15 parts by weight based on 100 parts by weight of total solids of the toner receiving layer.

11. The electrophotographic recording medium of claim 9, wherein the additive is at least one of an antistatic agent, a cross-linking agent, a dye, a light diffusing agent, a pH adjuster, an antioxidant, an antifoaming agent, a defoamer, a leveler, a lubricant, an anticurling agent, a surface conditioner, a thickener, a degradation inhibitor, an ozone degradation inhibitor, and an antiseptic.

12. The electrophotographic recording medium of claim 1, wherein the thickness of the toner receiving layer is in the range of 1 to 20 μm.

13. The electrophotographic recording medium of claim 1, further comprising an outermost layer formed on the toner receiving layer.

14. The electrophotographic recording medium of claim 13, wherein the outermost layer comprises a binder and a filler.

15. The electrophotographic recording medium of claim 13, wherein the thickness of the outermost layer is in the range of 5 to 15 μm.

16. The electrophotographic recording medium of claim 14, wherein an amount of the filler in the outermost layer is about 5 to 60 parts by weight based on 100 parts by weight of total solids of the outermost layer 22.

17. The electrophotographic recording medium of claim 14, wherein an amount of the binder in the outermost layer is about 40 to 95 parts by weight based on 100 parts by weight of total solids of the outermost layer 22.

18. The electrophotographic recording medium of claim 13, wherein the outermost layer further comprises an additive.
